(19) United States
(12) Patent Application Publication
(10) Pub. No.: US 2020/0312271 A1
(43) Pub. Date: Oct. 1, 2020

(54) METHOD AND APPARATUS TO AVOID VISUAL ARTIFACTS IN A DISPLAY DEVICE DURING A CONFIGURATION CHANGE

(71) Applicant: Intel Corporation, Santa Clara, CA (US)

(72) Inventors: Michael N. DERR, El Dorado Hills, CA (US); Arthur J. RUNYAN, Folsom, CA (US); Prashant D. CHAUDHARI, Folsom, CA (US)

(21) Appl. No.: 16/367,940

(22) Filed: Mar. 28, 2019

(51) Int. Cl. G09G 5/00

(52) U.S. Cl. CPC G09G 5/008; G09G 2360/04; G09G 2340/0407; G09G 2320/0252; G09G 2320/0247; G09G 2320/0266; G09G 2320/08

(57) ABSTRACT

Blanking on a display device (for example, a display monitor or a display panel) in a computer system is avoided by performing a configuration change during the vertical blanking period of a subsequent frame. Upon detecting a change in configuration of one or more display devices in the computer system, a display engine clock phase-locked loop is turned off, reprogrammed to a new frequency and relocked during the vertical blanking period of the subsequent frame.

### FIELD

This disclosure relates to graphics display devices and in particular to avoiding visual artifacts in a display device during a configuration change.

### BACKGROUND

A graphics processing unit (GPU) creates images in a frame buffer in memory to be displayed on a display device. Screen tearing is a visual artifact in a display device where a display device displays information from multiple frames when the frame buffer is being updated with a new image while the current image is being transmitted to the graphics display device.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a computer system that includes a display controller (also referred to as a display engine) and a system memory;

FIG. 2 is a block diagram illustrating an embodiment of the display engine clock frequency select circuitry shown in FIG. 1;

FIG. 3 is a flowgraph illustrating a method to avoid visual artifacts in a display device during a display device configuration change in a computer system;

FIG. 4 is an embodiment of a flow for display engine clock frequency transitions based on configuration/resolution for four display engine clock frequencies; and

FIG. 5 is a block diagram of an embodiment of a computer system that includes a display engine.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF EMBODIMENTS

Typically, changes to the image stored in the frame buffer in memory are synchronized with a vertical blanking interval for the display device to avoid screen tearing on the graphics display device. A display engine for display device(s) can be operated at the highest core display engine clock frequency to avoid visual artifacts on the display device. Running the display engine at the highest clock frequency results in unnecessary use of power that affects power available for use by compute and render engines in a computer system.

A configuration change in the computer system that may be caused by events such as the addition of a display device (for example, a display monitor or a display panel) to the computer system, or change of display resolution by workload or by a user, requires a corresponding change in the frequency of the display engine clock. Visual artifacts such as screen tearing, blanking and blinking may occur in a graphics display device during the configuration change in the computer system.

After system power on, a display device is configured as per enumeration and discovery of connected and enabled display devices during the system boot process. If a display configuration changes which requires changing of a clock frequency of a display engine clock, all of the active display device ports, display engine pipes and a phase-locked loop associated with the display engine clock are tuned off. All of the connected and enabled display devices no longer display an image, that is, the display devices display a “blank image” while power is applied to a phase-locked loop. The phase-locked loop is reprogrammed for the new display engine clock frequency (if required by the change to the display configuration, the phase-locked loop is relocked and new configuration changes are applied to the display engine pipeline) and the system operation continues.

Displaying a blank image (also referred to as “blanking”) on the display device is avoided by performing the configuration change during the vertical blanking period of a subsequent frame. Upon a request to modify the display configuration, the core display engine clock phase-locked loop is turned off, reprogrammed to a new frequency and relocked during the vertical blanking period of the subsequent frame.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

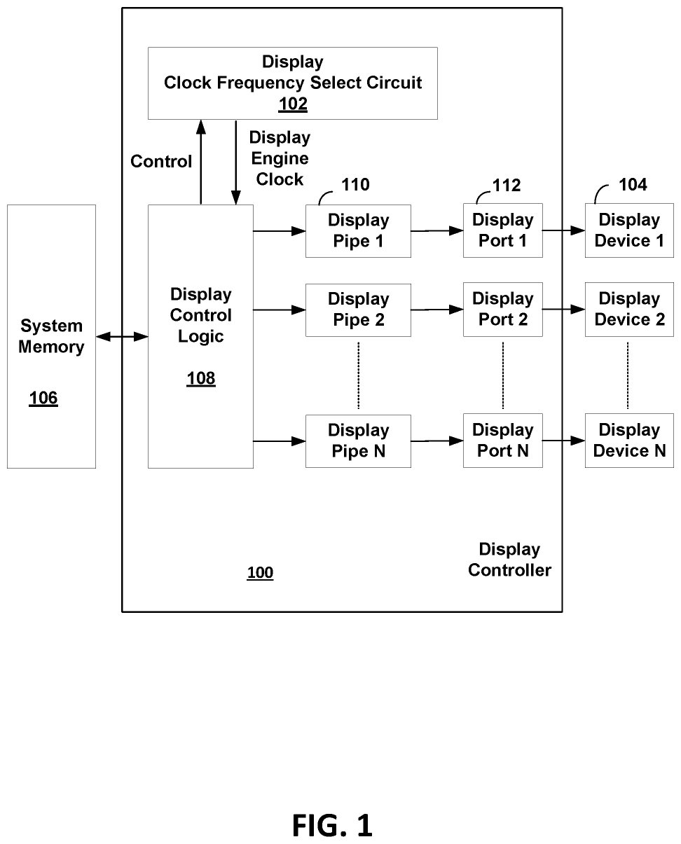

FIG. 1 is a block diagram of a computer system that includes a display controller 100 (also referred to as a display engine) and a system memory 106. A plurality of display devices (N) 104 can be communicatively coupled via one or more of N display ports 112 to the computer system. Each of the plurality of display ports 112 provides support for display interface protocols. Display interface protocols can include High-Definition Multimedia Interface (HDMI), Digital Video Interface (DVI), Mobile Industry Processor Interface-Display Serial Interface (MIPI-DSI), Universal Serial Bus type c (USBc), Wireless Display (WiDi), Video Graphics Array (VGA), Display Port (DP), DP multi-stream or embedded Display Port (eDP). DisplayPort multi-stream can have multiple pipes driving a single Digital Display Interface.

The image data stored in the frame buffer represents pixels to be displayed on the display. A pixel is the smallest addressable element in a display. For example, 32-bits in the frame buffer may represent one pixel in the display. For example, one or more of the 32-bits may represent the color of the pixel.

The display controller 100 uses a display engine clock (that can also be referred to as a core display clock or a display clock) to access the image(s) stored in system memory 106. The display engine clock is provided by display engine clock frequency select circuitry 102. The display controller 100 inserts the image(s) read from system memory 106 to a display pipe 110 for processing prior to being displayed on the display device 104.

Each display pipe 110 operates independently from the other display pipes. The display pipe 110 blends and synchronizes pixel data received from one or more display planes. In addition, the display pipe 110 adds timing for the display device 104 upon which the image is to be displayed. The display pipe 110 can perform operations on the image data including blending, color correction, display power saving (for example, adaptively reduce backlight brightness of the display device), scaling, dithering, and clipping.

Each of the display ports 112 includes transmit logic and a physical connector. A display device 104 can be coupled to the display port 112 via the physical connector. The display port 112 transmit data received from the respective display pipe 110 to the display device 104.

The display device 104 can be hot plugged into the display port 112 while both the display device 104 and the computer system are powered on. Hot plug detect (HPD) is supported by display protocols such as HDMI, display port and DVI. Typically, hot plug relies on a single pin in a display port connector to contact the display device 104 to initiate a hot plug process.

The display controller 100 also includes display engine clock frequency select circuitry 102. The frequency of the display engine clock impacts the maximum supported pixel rate. A display controller 100 (also referred to as a display engine) can be configured for the lowest display engine clock frequency necessary to support the current display configuration to save power. A display controller 100 may be configured to use a higher display engine clock frequency than necessary in order to reduce the need to change the frequency of the display engine clock when the display configuration is changed.

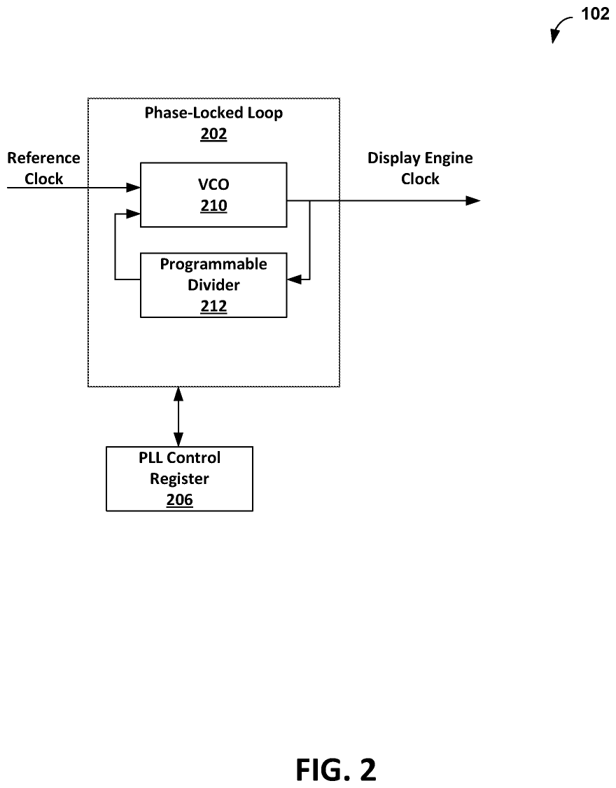

FIG. 2 is a block diagram illustrating an embodiment of the display engine clock frequency select circuitry 102 shown in FIG. 1. In the embodiment shown, the display engine clock frequency select circuitry 102 includes a phase-locked loop 202 and programmable divider circuitry 204. The phase-locked loop 202 includes a voltage controlled oscillator (VCO) 210 and programmable divider circuitry 212. A phase-locked loop is a closed-loop frequency-control system based on the phase difference between a reference clock and the feedback clock signal of the VCO 210. When the reference clock and the feedback clock are aligned, the phase-locked loop 202 is locked.

The reference clock and the feedback clock are input to the VCO 210 and the frequency of a feedback clock is modified via the programmable divider circuitry 212 until the phase-locked loop 202 is locked. The output of the phase-locked loop 202 is to provide a source clock for the display engine clock (that can also be referred to as a display clock or core display clock). The phase-locked loop 202 can be disabled via the PLL control register 206 to turn off the display engine clock. The frequency of the display engine clock can be selected dependent on a configuration of one or more display monitor(s) that are coupled to the display port(s). In an embodiment, the frequency of the display engine clock can be changed via the programmable divider circuitry 212.

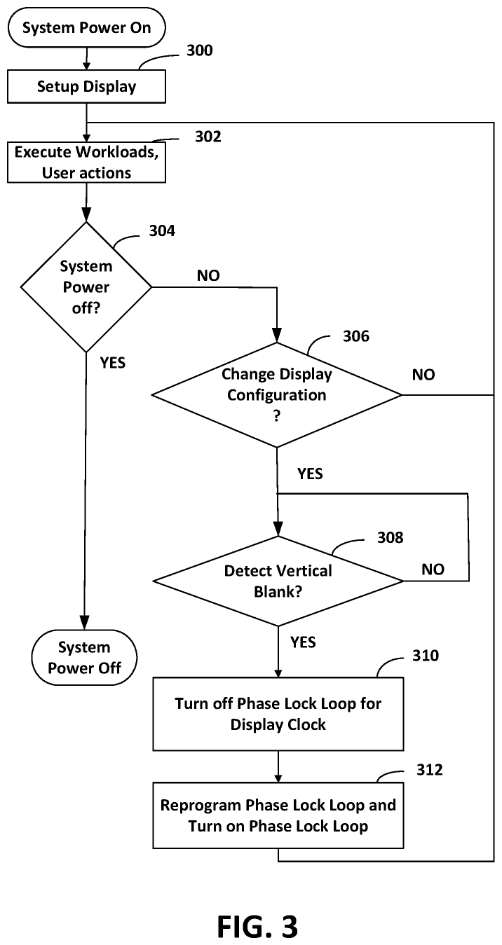

FIG. 3 is a flowgraph illustrating a method to avoid visual artifacts in a display device 104 during a display device configuration change in a computer system. A display device configuration change can be due to replacing a display device 104 with a higher or lower resolution display device 104 or by adding or removing one or more display devices 104 from the computer system.

A display device configuration change can be initiated by a workload or by a user request to change configuration that causes an increase or decrease in the display engine clock frequency. For example, a lower resolution or lower pixel throughput to be processed by the display pipe causes an increase in display engine clock frequency and a higher resolution or higher pixel throughput causes a decrease in display engine clock frequency.

At block 300, after power has been applied to a computer system, the computer system is booted. The boot process discovers one or more display devices 104 coupled to the computer system. The frequency of the display engine clock to be used by the computer system is based on the enumeration and discovery of connected and enabled display devices 104. The phase-locked loop 202 is configured to provide a display engine clock with the frequency required for the discovered display devices 104, for example, based on the number of enabled display devices 104 and the type of the enabled display devices 104.

At block 302, the computer system displays images on the discovered display devices 104 based on workload and user actions.

At block 304, if a power off event is detected, the computer system is shutdown. If not, processing continues with block 306.

At block 306, if a display configuration change is detected, processing continues with block 308. If not processing continues with block 302 to continue to display images on the current display device(s) 104 using the current configuration.

At block 308, a display configuration change that requires a change to the phase-locked loop 202 to modify the frequency of the display engine clock has been detected. For example, the configuration change can be detected as described earlier via hot plug detect by the display port 112 on the interface to the display device 104 due to user action to attach another display device 104 to the system. The hot plug detect can be a result of a removal of a connection to a display device 104 at the display port 112 or an addition of a display device 104 to a display port 112 that requires a change in the frequency of the display engine clock. The display configuration can also change due to a change in the resolution of a display device 104 that is communicatively coupled to the system by an application (based on workload) or user request that requires a change in the frequency of the display engine clock.

Upon detecting the display configuration change, the display control logic 108 waits until a start of a vertical blanking interval for a subsequent frame to be displayed on the display device communicatively coupled to the display port. The vertical blanking interval is a period of time during which image data is not transmitted through the display pipe 110 to the display port 112 and finally to the display device 104. Upon detection of the start of the vertical blanking interval, processing continues with block 310.

At block 310, the phase-locked loop 202 is disabled. In an embodiment, the phase-locked loop can be disabled by clearing an enable bit in the PLL control register 206 to indicate that the phase-locked loop 202 is to be disabled. The state of the enable bit can be polled to determine when the enable bit has been set to indicate that the phase-locked loop 202 is unlocked. In another embodiment, the PLL control register 206 can include an enable bit and a lock bit. After the enable bit is cleared to disable the phase-locked loop 202, the state of the lock bit can be polled to determine when the lock bit is cleared to indicate that the phase-locked loop is unlocked. The display pipe and display port continue to be enabled while the display engine clock is modified to maintain a link between the display port 112 and the display device so that a timing generator in the display pipe 110 can control the vertical blanking interval for the display device 104.

At block 312, after the display engine clock frequency has been modified, for example, via the programmable divider circuitry 204 discussed in conjunction with FIG. 1, the phase-locked loop 202 is enabled. In an embodiment, the phase-locked loop 202 is enabled by setting a PLL enable bit in the PLL control register 206 and the PLL enable bit in the PLL control register 206 is polled to detect when the phase-locked loop 202 is locked (for example, the enable bit is cleared). After the phase-locked loop 202 is locked and re-enabled it will be unstable for a period of time until it locks to a stable frequency.

The operations discussed in conjunction with block 310 and block 312 are performed during the vertical blanking interval of a display device when transitioning from one display to two display devices and from two display devices to one display device during which no active pixels are transmitted to the display device. Thus, there is no display blanking or tearing affect. The duration of the vertical blanking interval is more than 400 microseconds which is sufficient to turn off the display engine clock phase-locked loop and to reprogram the display engine clock phase-locked loop with the new frequency, relock the display engine clock phase-locked loop and to turn display pipe and display port (if turned off). Processing continues with block 302 to display images on the display device(s) based on the new configuration.

Modifying the display engine clock during the vertical blanking interval of a subsequent frame improves the user experience by avoiding blanking/blinking/tearing effects. In addition, the display engine clock frequency can be modified dynamically to save power. Furthermore, the power that is saved by reducing the display engine clock frequency can be used to perform other functions in the computer device, for example, compute or render functions to improve overall system performance.

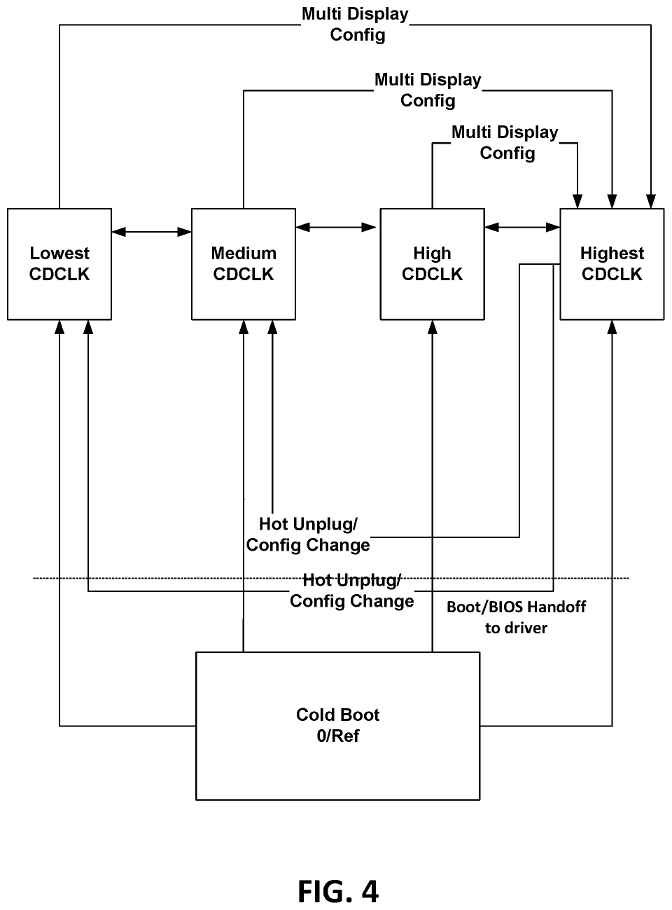

FIG. 4 is an embodiment of a flow for display engine clock frequency transitions based on changes in configuration/resolution of one or more display devices for four display engine clock frequencies. During a cold boot of the computer system, one or more display devices can be connected to the computer system. These display devices are discovered by the display controller and the display engine clock frequency is selected and configured via the display engine clock frequency select circuitry 102. In the flow shown in FIG. 4, the display engine clock can be configured for four different display engine clock frequencies, a lowest clock frequency, a medium display engine clock frequency, a high display engine clock frequency or a highest display engine clock frequency.

In an embodiment, the lowest display engine clock frequency is configured if one display device having a display panel with 2K or less pixels is discovered during the boot process in the computer system. The medium display engine clock frequency is configured if one display panel with 4K pixels is discovered during the boot process in the computer system. The high display engine clock frequency is configured if one display panel with 5K pixels is discovered during the boot process in the computer system.

The high display frequency is also configured if more than one display device is discovered during the boot process in the computer system and there is not any higher resolution setting further allowed in the system configuration. The highest display frequency can be configured if more than one display device is discovered during the boot process in the computer system and it is a maximum stress configuration. An example of a maximum stress configuration is if all ports and planes are enabled for the maximum concurrent resolution setting.

As shown in FIG. 4, during operation of the computer system, the display engine clock frequency can be modified on a hot unplug for any of the display devices from the computer system or reconfiguration of the display devices in the computer system to lower resolution display devices or the removal, addition or replacement of display devices to the computer system. The display engine clock frequency can be changed from the lowest clock frequency to the highest clock frequency or from the highest clock frequency to the lowest clock frequency due to a hot unplug or a configuration change. In an embodiment, the computer system can include an internal display that can be a low resolution display (for example, 800×600 pixels) with the display engine clock set to the lowest display engine clock. The addition of an external display monitor with a high resolution (for example, 8K pixels) results in a transition to the highest display engine clock. Disabling of the external monitor and configuring the internal display by a user for a resolution of 2800×1800 pixels results in a transition to the medium display engine clock or configuring the internal display for a resolution of 4K pixels based on type of application (for example, to play a movie) results in a transition to the high display engine clock. The dropping of the resolution to 800×600 pixels based on a workload that requires a lower resolution (for example, an application to display a weather screen or a clock mode) results in a transition to the lowest display engine clock.

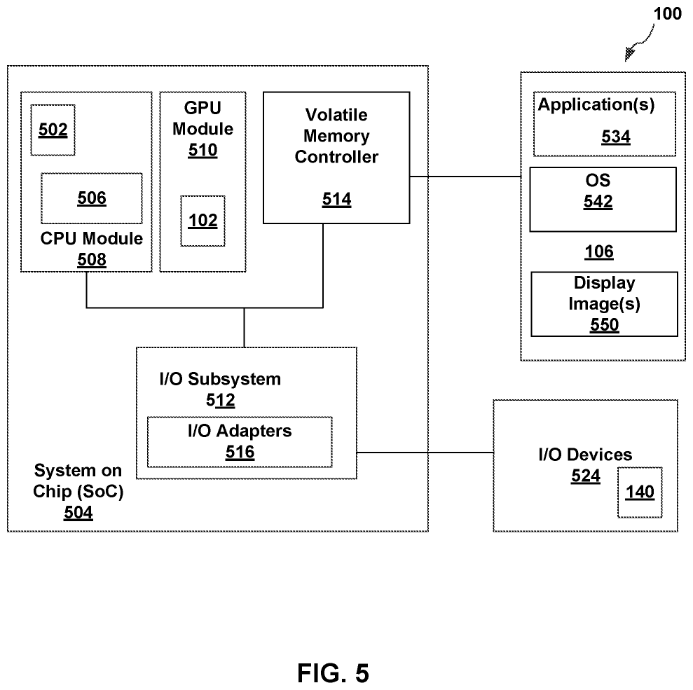

FIG. 5 is a block diagram of an embodiment of a computer system 500 that includes a display engine. Computer system 500 can correspond to a computing device including, but not limited to, a server, a workstation computer, a desktop computer, a laptop computer, mobile device, smartphone device, wearable device, and/or a tablet computer.

The computer system 500 includes a system on chip (SOC or SoC) 504 which combines processor, graphics, memory, and Input/Output (I/O) control logic into one SoC package. The SoC 504 includes at least one Central Processing Unit (CPU) module 508, a volatile memory controller 514, and a Graphics Processor Unit (GPU) 510.

The Graphics Processor Unit (GPU) 510 can include one or more GPU cores and a GPU cache which can store graphics related data for the GPU core. The GPU 510 includes a display engine 502 as described in conjunction with FIGS. 1-4 that provides a better graphics user experience by eliminating undesirable blanking or tearing of display images upon dynamic configuration changes. The SoC 504 can operate at the optimum display engine clock frequency to save power and so that the saved power can be used by compute or render circuitry to increase throughput.

Display images 550 stored in volatile memory can be displayed on display device(s) 540. The GPU core can internally include one or more execution units and one or more instruction and data caches. Additionally, the Graphics Processor Unit (GPU) 510 can contain other graphics logic units that are not shown in FIG. 5, such as one or more vertex processing units, rasterization units, media processing units, and codecs.

Within the I/O subsystem 512, one or more I/O adapter(s) 516 are present to translate a host communication protocol utilized within the processor core(s) 502 to a protocol compatible with particular I/O devices. Some of the protocols that adapters can be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 516 can communicate with external I/O devices 524 which can include, for example, user interface device(s) including a display and/or a touch-screen display device(s) 540, printer, keypad, keyboard, communication logic, wired and/or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The storage devices can be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)).

The I/O adapters 516 can include a Peripheral Component Interconnect Express (PCIe) adapter that is communicatively coupled using the NVMe (NVM Express) over PCIe (Peripheral Component Interconnect Express) protocol over a bus 544 to a Solid State Drive. Non-Volatile Memory Express (NVMe) standards define a register level interface for host software to communicate with a non-volatile memory subsystem (for example, a Solid-state Drive (SSD)) over Peripheral Component Interconnect Express (PCIe), a high-speed serial computer expansion bus). The NVM Express standards are available at www.nvmexpress.org. The PCIe standards are available at www.pcisig.com.

Additionally, there can be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

In other embodiments, the volatile memory controller 514 can be external to the SoC 504. Although not shown, each of the processor core(s) 502 can internally include one or more instruction/data caches, execution units, prefetch buffers, instruction queues, branch address calculation units, instruction decoders, floating point units, retirement units, etc. The CPU module 508 can correspond to a single core or a multi-core general purpose processor, such as those provided by Intel® Corporation, according to one embodiment.

Volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein can be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5, HBM2 (HBM version 2), currently in discussion by JEDEC, or others or combinations of memory technologies, and technologies based on derivatives or extensions of such specifications. The JEDEC standards are available at www.jedec.org.

An operating system 542 is software that manages computer hardware and software including memory allocation and access to I/O devices. Examples of operating systems include Microsoft® Windows®, Linux®, iOS® and Android®.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

1. An apparatus comprising:
a display controller to control a plurality of display devices, the display controller to include a plurality of display pipes and a plurality of display ports, each of the display ports to include a physical connector to couple to one of the plurality of display devices, the display device to transmit data received from one of the plurality of display pipes to one of the plurality of display devices; and
a phase-locked loop communicatively coupled to the display controller to control a display engine clock frequency, the display engine clock frequency dynamically selected based on a configuration of the plurality of display devices, upon detecting a change in a configuration of the plurality of display devices, the display controller to turn off the phase-locked loop, reprogram the phase-locked loop for a new display engine clock frequency and enable the phase-locked loop to lock to the new display engine clock frequency during a vertical blanking period of a subsequent frame to be displayed by the display controller.

2. The apparatus of claim 1, wherein the display engine clock frequency is increased when the change in the configuration is addition of a display device.

3. The apparatus of claim 1, wherein the display engine clock frequency is decreased when the change in the configuration is removal of a display device.

4. The apparatus of claim 1, wherein the display engine clock frequency is increased when the change in the configuration is replacement of a first display device with a second display device, the second display device having a higher resolution than the first display device.

5. The apparatus of claim 1, wherein the display engine clock frequency is decreased when the change in the configuration is replacement of a first display device with a second display device, the second display device having a lower resolution than the first display device.

6. The apparatus of claim 1, wherein the display engine clock frequency is decreased when the change in the configuration is by a user or a workload to require a lower resolution or a lower pixel throughput of a display device.

7. The apparatus of claim 1, wherein the display engine clock frequency is increased when the change in the configuration is by a user or a workload to require a higher resolution or a higher pixel throughput of a display device.

8. A method comprising:
dynamically selecting a display engine clock frequency for a display controller based on a configuration of a plurality of display devices, the display controller to include a plurality of display pipes and a plurality of display ports, each of the display ports to include a physical connector to couple to one of the plurality of display devices, the display device to transmit data received from one of the plurality of display pipes to one of the plurality of display devices;
controlling, by a phase-locked loop, the display engine clock frequency; and
upon detecting a change in a configuration of the plurality of display devices, turning off the phase-locked loop, reprogramming the phase-locked loop for a new display engine clock frequency and enabling the phase-locked loop to lock to the new display engine clock frequency during a vertical blanking period of a subsequent frame to be displayed.

9. The method of claim 8, wherein the display engine clock frequency is increased when the change in the configuration is addition of a display device.

10. The method of claim 8, wherein the display engine clock frequency is decreased when the change in the configuration is removal of a display device.

11. The method of claim 8, wherein the display engine clock frequency is increased when the change in the configuration is replacement of a first display device with a second display device, the second display device having a higher resolution than the first display device.

12. The method of claim 8, wherein the display engine clock frequency is decreased when the change in the configuration is replacement of a first display device with a second display device, the second display device having a lower resolution than the first display device.

13. The method of claim 8, wherein the display engine clock frequency is decreased when the change in the configuration is by a user or a workload to require a lower resolution or a lower pixel throughput of a display device.

14. The method of claim 8, wherein the display engine clock frequency is increased when the change in the configuration is by a user or a workload to require a higher resolution or a higher pixel throughput of a display device.

15. A system comprising:
a plurality of display devices;
a display controller communicatively coupled to the plurality of display devices, the display controller to include a plurality of display pipes and a plurality of display ports, each of the display ports to include a physical connector to couple to one of the plurality of display devices, the display device to transmit data received from one of the plurality of display pipes to one of the plurality of display devices; and
a phase-locked loop communicatively coupled to the display controller to control a display engine clock frequency, the display engine clock frequency dynamically selected based on a configuration of the plurality of display devices, upon detecting a change in a configuration of the plurality of display devices, the display controller to turn off the phase-locked loop, reprogram the phase-locked loop for a new display engine clock frequency and enable the phase-locked loop to lock to the new display engine clock frequency during a vertical blanking period of a subsequent frame to be displayed by the display controller.

16. The system of claim 15, wherein the display engine clock frequency is increased when the change in the configuration is addition of a display device.

17. The system of claim 15, wherein the display engine clock frequency is decreased when the change in the configuration is removal of a display device.

18. The system of claim 15, wherein the display engine clock frequency is increased when the change in the configuration is replacement of a first display device with a second display device, the second display device having a higher resolution than the first display device.

19. The system of claim 15, wherein the display engine clock frequency is decreased when the change in the configuration is replacement of a first display device with a second display device, the second display device having a lower resolution than the first display device.

20. The system of claim 15, wherein the display engine clock frequency is decreased when the change in the configuration is by a user or a workload to require a lower resolution or a lower pixel throughput of a display device.

21. The system of claim 15, wherein the display engine clock frequency is increased when the change in the configuration is by a user or a workload to require a higher resolution or a higher pixel throughput of a display device.
